(19) United States
(12) Patent Application Publication
(10) Pub. No.: US 2023/0312252 A1
(43) Pub. Date: Oct. 5, 2023

(54) A METHOD FOR REPLACING SEEDBED CULTURE SUBSTRATE AND A CONVEYOR BELT SEEDBED

(71) Applicants: Guiyang PENG, Haikou City, Hainan (CN); HAINAN DENDROBIUM HEALTH INDUSTRY CO.,LTD., Haikou City, Hainan (CN)

(72) Inventors: Guiyang PENG, Haikou City, Hainan (CN); Wu LI, Haikou City, Hainan (CN); Xiangming NING, Haikou City, Hainan (CN); Wanxing ZHANG, Haikou City, Hainan (CN); Xiaoping CHEN, Haikou City, Hainan (CN); Haisong FU, Haikou City, Hainan (CN); Guobing WU, Haikou City, Hainan (CN); Wei DENG, Haikou City, Hainan (CN)

(21) Appl. No.: 17/624,277

(22) PCT Filed: Dec. 27, 2021
(86) PCT No.: PCT/CN2021/141703

§ 371 Date: Dec. 31, 2021

(30) Foreign Application Priority Data
Jan. 5, 2021 (CN) 202110007582.6

(51) Int. Cl. B65G 13/06; A01G 24/00

(52) U.S. Cl. CPC B65G 13/06; A01G 24/00; B65G 2201/0202

(57) ABSTRACT

The application discloses a method for replacing seedbed culture substrate and a conveyor belt seedbed, the flatbed truck is used to receive the dropped culture substrate at the end of the conveyor belt that has been driven all the time, without manual removal by workers. The conveyor belt continues to drive until the flatbed truck is fully loaded or only when the culture substrate on the conveyor belt is emptied, only need to place the flatbed truck full of culture substrate at the head end of the conveyor belt when placing new culture substrate, and turn on the conveyor belt, which speeds up the efficiency of replacing the culture substrate, and this method only requires one person can complete the replacement of the culture substrate on the seedbed, which solves the technical problem that the existing method of replacing the culture substrate is to manually remove the culture substrate on the seedbed, which leads to the long time for replacing the culture substrate and low work efficiency.

### TECHNICAL FIELD

This invention relates to the technical field of seedbeds, in particular to a method for replacing seedbed culture substrate and conveyor belt seedbeds.

### BACKGROUND ART

Dendrobium nobile, also known as Chlorophytum, is a commonly used precious Chinese medicinal material. Dendrobium is used as medicine with stems. It is cold in nature and sweet in taste. It has the effects of invigorating the stomach, nourishing fluid, nourishing yin and clearing away heat. It can be used for treating fever, thirst, asthenic heat after illness, scanty tongue fur, scanty food, retching, blurred vision, etc.

The preciousness of Dendrobium nobile is that its growth environment needs to be suitable, the selection requirements are high, especially the cultivation process is long. Mature seeds begin to germinate 12 days after aseptic sowing, and after 60 days, they can grow about 1 cm high, with 2-3 true leaf bulbs, and begin to root. After the bulbs are inoculated in a domestication medium and cultured for 60 days, they are transferred to a proliferation medium for cultivation. After about 60 days, each seedling can form 3-7 lateral buds. In the process of proliferation and culture, as the number of successive generations increases, the ability of seedlings to form lateral buds increases and the number increases. Normal seedlings with a height of about 2 cm in the growth medium are inoculated on the growth medium for cultivation. At this time, the seedlings, because the pseudobulbs are relatively tender and the root system is longer, the survival rate of transplanting out of the bottle is lower. After the longer root system of the strong and mature seedlings is properly cut off, the seedlings are transferred to the strong seedling medium for cultivation. After 13 days, the seedlings will grow up and new roots will re-grow. After 30 days, the mature leaves of the seedlings become light yellow-green, the toughness of the pseudobulbs increases, the root system is developed, 1-2 cm long, white or light green, and with a lot of white root hairs. Transplanting can be carried out at this time. It takes 9-10 months to cultivate the seeds of Dendrobium nobile from sowing to refining the seedlings.

Every 10 months or so, the culture substrate of Dendrobium nobile becomes decayed due to climatic factors and insect pests. The decaying culture substrate will damage the seedlings of Dendrobium nobile. Therefore, workers need to replace the culture substrate of Dendrobium nobile every 10 months, but the existing method of replacing the culture substrate is to manually remove the culture substrate on the seedling bed, which leads to a long time to replace the culture substrate and low work efficiency.

### SUMMARY OF THE INVENTION

The embodiments of the application provide a method for replacing culture substrate and a conveyor belt seedbed to solve the problem that the existing method of replacing the culture substrate requires manual removal of the culture substrate on the seedbed, resulting in a long time for replacing the culture substrate and low work efficiency technical issues.

In view of this, the first aspect of the present application provides a method for replacing seedbed culture substrate, which is applied to the conveyor belt seedbed, including the following steps:
S1: Before changing the culture substrate, place a flatbed truck at the end of the conveyor belt of the conveyor belt seedbed to catch the culture substrate;
S2: Run the conveyor belt;
S3: After the flatbed truck is fully loaded, control the conveyor belt to stop running, and repeat steps S1-S3, until the culture substrate on the conveyor belt is emptied, and then execute step S4;
S4: Lay the new culture substrate on the conveyor belt from the head end of the conveyor belt by using a flatbed truck loaded with new culture substrate;
S5: Run the conveyor belt until the new culture substrate is spread on the conveyor belt, then stop the conveyor belt;
Wherein, the conveyor belt seedbed includes a seedbed frame, a support, a conveyor belt mechanism, an electric control box and a driving motor;
The support member is installed on the seedbed frame and is parallel to the front and rear sides of the seedbed frame, and the support member is set lower than the front and rear sides of the seedbed frame;
The conveyor belt mechanism includes the conveyor belt and a rotating shaft;
The rotating shafts are respectively arranged on the left and right sides of the top of the seedbed frame through bearing seats, and are located at the two ends of the support;
The head and tail ends of the conveyor belt are driven by the rotating shafts on the left and right sides of the top of the seedbed frame;
The rotating shaft is connected with the output shaft of the driving motor;
The electric control box is electrically connected with the driving motor;
The electric control box and the driving motor are both installed on the seedbed frame.

Wherein, in step S1, before replacing the culture substrate, the luminous flux of visible light received on the conveyor belt seedbed is controlled to be 36%-55%.

Wherein, in step S2, a speed governor electrically connected to the driving motor is used to adjust the speed of the conveyor belt to 1.5 m/s.

Wherein, in step S5, the speed of the conveyor belt is adjusted to 0.5 m/s using a speed governor electrically connected to the drive motor.

Wherein, in step S4, the flatbed truck loaded with new culture substrate is lifted above the head end of the conveyor belt.

The second aspect of the application provides a conveyor belt seedbed, including: a seedbed frame, a support, a conveyor belt mechanism, an electric control box and a driving motor;
The support member is installed on the seedbed frame and is parallel to the front and rear sides of the seedbed frame, and the support member is set lower than the front and rear sides of the seedbed frame;
The conveyor belt mechanism includes the conveyor belt and the rotating shaft;
The rotating shafts are respectively arranged on the left and right sides of the top of the seedbed frame through the bearing seats, and are located at the two ends of the support;
The head and tail ends of the conveyor belt are driven by the rotating shafts on the left and right sides of the top of the seedbed frame;
The rotating shaft is connected with the output shaft of the driving motor;
The electric control box is electrically connected with the driving motor;
The electric control box and the drive motor are both installed on the seedbed frame.

Wherein, the support is a guide rail, and the guide rail is located between the upper layer and the lower layer of the conveyor belt;

The number of said guide rails is more than two.

Wherein, the electric control box is connected to the drive motor through the governor.

Wherein, the conveyor belt is provided with a plurality of ventilation holes.

Wherein, the bottom of the support foot of the seedbed frame is provided with universal wheels.

It can be seen from the above technical solutions that the embodiments of the present application have the following advantages:

This application provides a method for replacing seedbed culture substrate, including: applying it on a conveyor belt seedbed, including the following steps: S1: Before changing the culture substrate, place a flatbed truck at the end of the conveyor belt of the conveyor belt seedbed to catch the culture substrate; S2: Run the conveyor belt; S3: After the flatbed truck is fully loaded, control the conveyor belt to stop running, and repeat steps S1-S3, until the culture substrate on the conveyor belt is emptied, and then execute step S4; S4: Lay the new culture substrate on the conveyor belt from the head end of the conveyor belt by using a flatbed truck loaded with new culture substrate; S5: Run the conveyor belt until the new culture substrate is spread on the conveyor belt, then stop the conveyor belt; Wherein, the conveyor belt seedbed includes: a seedbed frame, a support, a conveyor belt mechanism, an electric control box and a driving motor; the support member is installed on the seedbed frame and is parallel to the front and rear sides of the seedbed frame, and the support member is set lower than the front and rear sides of the seedbed frame; the conveyor belt mechanism includes the conveyor belt and a rotating shaft; the rotating shafts are respectively arranged on the left and right sides of the top of the seedbed frame through bearing seats, and are located at the two ends of the support; the head and tail ends of the conveyor belt are driven by the rotating shafts on the left and right sides of the top of the seedbed frame; the rotating shaft is connected with the output shaft of the driving motor; the electric control box is electrically connected with the driving motor; the electric control box and the driving motor are both installed on the seedbed frame.

The method for replacing seedbed culture substrate provided in this application, When replacing the culture substrate, use a flatbed truck to receive the fallen culture substrate at the end of the conveyor belt that has been driving. There is no need for workers to remove it manually. The conveyor belt continues to drive until the flatbed truck is fully loaded or the culture substrate on the conveyor belt is emptied. Just place the flatbed full of culture substrate at the head end of the conveyor belt and turn on the conveyor belt, which speeds up the efficiency of replacing the culture substrate, and this method requires only one person to complete the replacement of the culture substrate on the seedling bed. The culture substrate on the seedling bed solves the technical problems that the existing method of replacing the culture substrate requires manual removal of the culture substrate on the seedling bed, resulting in a long time to replace the culture substrate and low work efficiency.

### BRIEF DESCRIPTION OF THE DRAWINGS

FIG. 1 is a front view of the conveyor belt seedbed provided in an embodiment of the application;

FIG. 2 is an axial view of the conveyor belt seedbed provided in an embodiment of the application;

FIG. 3 is a schematic diagram of the structure of the seedbed frame and support provided in an embodiment of the application;

FIG. 4 is a schematic diagram of the structure of the supporting member and the connecting rod provided in the embodiment of the application;

FIG. 5 is a schematic diagram of the structure of the supporting member and the conveyor belt mechanism provided in the embodiment of the application;

Among them, the reference signs are:

1. Seedbed frame; 11. Support feet; 12. Connecting plate; 13. Connecting rod; 2. Electric control box; 3. Drive motor; 4. Governor; 5. Universal wheel; 6. Conveyor belt; 7. Fixed plate; 8. Support; 81. Through hole; 9. Rotation shaft.

### DETAILED DESCRIPTION OF SOME EMBODIMENTS

In order to make people in the technical field better understand this application scheme, the technical scheme in this application embodiment will be clearly and completely described with reference to the drawings in this application embodiment. Obviously, the described embodiment is only a part of this application embodiment, not all of it. Based on the examples in this application, all other examples obtained by ordinary technicians in the field without creative work are within the scope of protection of this application.

In the description of the embodiment of this application, it should be noted that the orientation or positional relationship indicated by the terms “center”, “upper”, “lower”, “left”, “right”, “vertical”, “horizontal”, “inside” and “outside” is based on the orientation or positional relationship shown in the drawings, only for the convenience of describing the embodiment of this application and simplifying the description, rather than indicating. In addition, the terms “first”, “second” and “third” are used for descriptive purposes only, and cannot be understood as indicating or implying relative importance.

In the description of the embodiments of this application, it should be noted that the terms “installation”, “connection” and “connection” should be understood broadly, for example, they can be fixed connection, detachable connection or integrated connection. Can be mechanically connected or electrically connected; can be directly connected, can also be indirectly connected through an intermediate medium, and can be the internal communication of two elements. For ordinary technicians in the field, the specific meanings of the above terms in the application examples can be understood in specific situations.

### Embodiment. 1

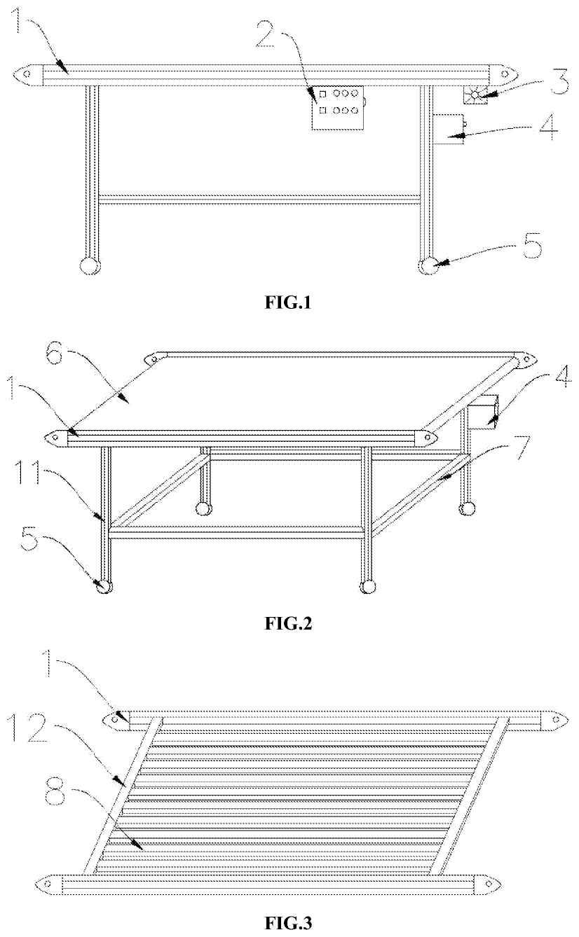

For ease of understanding, please refer to FIG. 1 to FIG. 5. An embodiment of the first method for replacing seedbed culture substrate provided by this application includes: application on a conveyor belt seedbed, including the following steps:
S1: Before changing the culture substrate, place a flatbed truck at the end of the conveyor belt of the conveyor belt 6 seedbed to catch the culture substrate;
S2: Run the conveyor belt 6;
S3: After the flatbed truck is fully loaded, control conveyor belt 6 to stop running, and steps S1-S3, until the culture substrate on the conveyor belt 6 is emptied, and then execute step S4;
S4: Lay the new culture substrate on the conveyor belt 6 from the head end of the conveyor belt 6 through the flatbed truck loaded with new culture substrate;
S5: Run the conveyor belt 6 until the new culture substrate is spread on the conveyor belt 6, then stop the conveyor belt 6;

Wherein, the conveyor belt seedbed includes: a seedbed frame 1, a support 8, a conveyor belt mechanism, an electric control box 2 and a drive motor 3. The support 8 is installed on the seedbed frame 1 and is parallel to the front and rear sides of the seedbed frame 1, and the support 8 member is set lower than the front and rear sides of the seedbed frame 1; the conveyor belt mechanism includes the conveyor belt 6 and a rotating shaft 9; the rotating shafts 9 are respectively arranged on the left and right sides of the top of the seedbed frame 1 through bearing seats, and are located at the two ends of the support 8; the head and tail ends of the conveyor belt 6 are driven by the rotating shafts on the left and right sides of the top of the seedbed frame 1; the rotating shaft 9 is connected with the output shaft of the driving motor 3; the electric control box 2 is electrically connected with the driving motor 3; the electric control box 2 and the driving motor 3 are both installed on the seedbed frame 1.

It should be noted that, in step S1, before replacing the culture substrate, place the flatbed truck for catching the culture substrate below the end of the conveyor belt 6 to facilitate catching the culture substrate falling from the end of the conveyor belt 6. In step S2, before running the conveyor belt 6, it is necessary to start the electric control box 2 and the driving motor 3, and then drive the rotating shaft 9 of the conveyor belt mechanism to operate, and then the conveyor belt 6 will be driven accordingly. In step S3, because the area of the conveyor belt seedbed is larger than the area of the flatbed truck, when the flatbed truck catches the culture substrate dropped from the conveyor belt seedbed, it cannot load all the culture substrate at one time. It needs to be loaded several times, which is also convenient for workers. We transport the culture substrate to an area away from the seedbed until the culture substrate on the conveyor belt is emptied. In step S5, after stopping the conveyor belt 6, in order to avoid wasting electricity, it is necessary to turn off the drive motor 3 and the electric control box 2 in turn.

The method for replacing seedbed culture substrate provided in this application, When replacing the culture substrate, use a flatbed truck to receive the fallen culture substrate at the end of the conveyor belt 6 that has been driving. There is no need for workers to remove it manually. The conveyor belt 6 continues to drive until the flatbed truck is fully loaded or the culture substrate on the conveyor belt 6 is emptied. Just place the flatbed full of culture substrate at the head end of the conveyor belt 6 and turn on the conveyor belt 6, which speeds up the efficiency of replacing the culture substrate, and this method requires only one person to complete the replacement of the culture substrate on the seedling bed. The culture substrate on the seedling bed solves the technical problems that the existing method of replacing the culture substrate requires manual removal of the culture substrate on the seedling bed, resulting in a long time to replace the culture substrate and low work efficiency.

### Embodiment.2

For ease of understanding, please refer to FIG. 1 to FIG. 5. As a further improvement of Example.1, in step S1, before replacing the culture substrate, the luminous flux of visible light received on the conveyor belt seedbed is controlled to be 36%-55%. In step S2, a speed governor 4 electrically connected to the driving motor 3 is used to adjust the speed of the conveyor belt 6 to 1.5 m/s. In step S5, the speed of the conveyor belt 6 is adjusted to 0.5 m/s using a speed governor 4 electrically connected to the drive motor 3. In step S4, the flatbed truck loaded with new culture substrate is lifted above the head end of the conveyor belt 6.

It should be noted that, in order to prevent the culture substrate from being exposed to the sun, a sunshade net can be hung on the conveyor bed to keep the luminous flux of visible light received by the conveyor bed at 36%˜55%. When changing the culture substrate, it is necessary to quickly drive the culture substrate on the conveyor belt 6 to the flatbed truck, so it is necessary to use the governor 4 to adjust to 1.5 m/s, which can reduce the time for changing the culture substrate and speed up the replacement efficiency; When cultivating the substrate, the transmission speed of the conveyor belt 6 needs to be adjusted to 0.5 m/s, which is beneficial to slowly place the culture substrate on the conveyor belt 6. If there is a culture substrate that does not cover the conveyor belt 6, it is also convenient for workers to manually fill it. In order to facilitate the placement of the new culture substrate from the flatbed truck loaded with the new culture substrate on the conveyor belt 6, the height of the flatbed truck is slightly higher than the head end of the conveyor belt 6.

### Embodiment.3

For ease of understanding, please refer to FIG. 1 to FIG. 5. This application provides an embodiment of a conveyor belt seedbed, including: a seedbed frame 1, a support 8, a conveyor belt mechanism, an electric control box 2 and a driving motor 3; the support member 8 is installed on the seedbed frame 1 and is parallel to the front and rear sides of the seedbed frame 1, and the support member 8 is set lower than the front and rear sides of the seedbed frame 1; the conveyor belt mechanism includes the conveyor belt 6 and the rotating shaft 9; the rotating shafts 9 are respectively arranged on the left and right sides of the top of the seedbed frame 1 through the bearing seats, and are located at the two ends of the support 8; the head and tail ends of the conveyor belt 6 are driven by the rotating shafts 9 on the left and right sides of the top of the seedbed frame 1; the rotating shaft 9 is connected with the output shaft of the driving motor 3; the electric control box 2 is electrically connected with the driving motor 3; the electric control box 2 and the drive motor 3 are both installed on the seedbed frame 1.

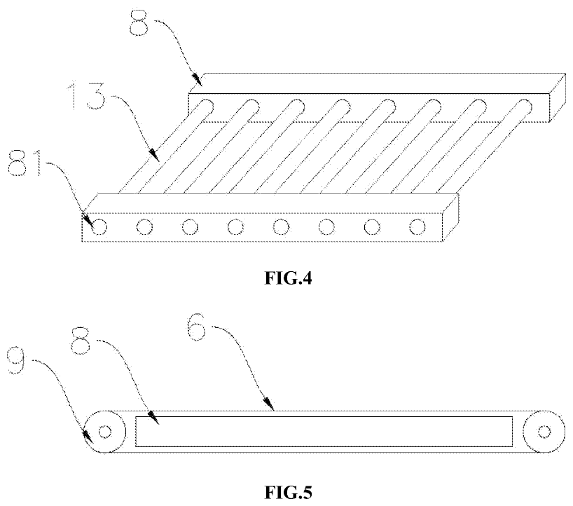

It should be noted that, as shown in FIG. 4, the seedbed frame 1 may be equipped with connecting rods 13, which are parallel to the left and right sides of the seedbed frame 1, and each connecting rod 13 respectively penetrates through holes 81 provided at equal intervals in the middle of the support 8; as shown in FIG. 3, The seedbed frame 1 can also be equipped with connecting plates 12 parallel to the left and right sides of the seedbed frame 1. One end of the support 8 is connected to the left connecting plate 12, and the other end is connected to the right connecting plate 12. The support 8 serves to support the conveyor belt 6. The effect is to prevent the culture substrate on the conveyor belt 6 from being too heavy causing the conveyor belt 6 to dent in the middle. Slide to the outside. The electric control box 2 can be installed on the bottom of the support 8 or on the support feet 11 of the seedbed frame 1. When changing the culture substrate or laying a new culture substrate, the running conveyor belt 6 will dent in the middle due to the heavy weight of the culture substrate, which will affect the transmission speed of the conveyor belt 6. With the support 8 for support, the conveyor belt 6 can be kept at a level drive forward in the direction to speed up the transmission speed and improve the work efficiency of changing the culture substrate or laying new culture substrate.

### Embodiment.4

For ease of understanding, please refer to FIG. 1 to FIG. 5. As a further improvement of Example.3, the support 8 is a guide rail, and the guide rail is located between the upper layer and the lower layer of the conveyor belt 6; the number of said guide rails is more than two. The electric control box 2 is connected to the drive motor 3 through the governor 4. The conveyor belt 6 is provided with a plurality of through holes 81. The bottom of the support foot 11 of the seedbed frame 1 is provided with universal wheels 5.

It should be noted that, the culture substrate placed on the upper layer of the conveyor belt 6 will be heavier after watering, which will affect the transmission speed of the conveyor belt 6. The support 8 is a guide rail, which can speed up the transmission speed of the conveyor belt 6 and reduce the transmission time of the conveyor belt 6, in order to prevent the conveyor belt 6 from moving between the guide rails. In order to prevent the conveyor belt 6 from denting to both sides of the guide rail, and the number of guide rails is more than two; because the drive motor 3 in this embodiment is a non-adjustable speed drive motor, in order to facilitate the control of the transmission speed of the conveyor belt 6, the electric control box 2 is connected to the drive motor 3 through the governor 4, It is beneficial to drive the motor 3 to adjust the speed of the conveyor belt 6. Since the culture substrate close to the conveyor belt 6 needs to be ventilated, and the excess water needs to flow out from the conveyor belt 6 after watering, a number of through holes 81 are set on the conveyor belt 6 to prevent the accumulation of water from soaking the culture substrate for too long, which may cause rot and affect the seedlings growth. In order to facilitate the movement of the conveyor belt seedbed, a universal wheel 5 can be provided at the bottom of the support feet 11 of the seedbed frame 1, which is helpful for workers to push the conveyor belt seedbed.

Although the present invention has been described using the above-mentioned preferred embodiments, it is not intended to limit the scope of protection of the present invention, anyone skilled in the art can make various changes and modifications to the above-mentioned embodiments without departing from the spirit and scope of the present invention, and that still belong to the scope of protection of the present invention, so the protection scope of the present invention is defined by the claims.

1. A method for replacing seedbed culture substrate, which is characterized in that it is applied to a conveyor belt seedbed and comprises the following steps:
S1: Before changing the culture substrate, place a flatbed truck at the end of the conveyor belt of the conveyor belt seedbed to catch the culture substrate;
S2: Run the conveyor belt;
S3: After the flatbed truck is fully loaded, control the conveyor belt to stop running, and repeat steps S1-S3 until the culture substrate on the conveyor belt is emptied, and then execute step S4;
S4: Lay the new culture substrate on the conveyor belt from the head end of the conveyor belt by using a flatbed truck loaded with new culture substrate;
S5: Run the conveyor belt until the new culture substrate is spread on the conveyor belt, then stop the conveyor belt;
Wherein, the conveyor belt seedbed includes /a seedbed frame, a support, a conveyor belt mechanism, an electric control box and a driving motor;
The support member is installed on the seedbed frame and is parallel to the front and rear sides of the seedbed frame, and the support member is set lower than the front and rear sides of the seedbed frame;
The conveyor belt mechanism includes the conveyor belt and a rotating shaft;
The rotating shafts are respectively arranged on the left and right sides of the top of the seedbed frame through bearing seats, and are located at the two ends of the support;
The head and tail ends of the conveyor belt are driven by the rotating shafts on the left and right sides of the top of the seedbed frame;
The rotating shaft is connected with the output shaft of the driving motor;
The electric control box is electrically connected with the driving motor;
The electric control box and the driving motor are both installed on the seedbed frame.

2. The method for replacing the seedbed culture substrate according to claim 1, characterized in that in step S1, before replacing the culture substrate, the luminous flux of visible light received on the conveyor belt seedbed is controlled to be 36%-55%.

3. The method for replacing the seedbed culture substrate according to claim 1, charactered in that wherein in step S2, the speed of the conveyor belt is adjusted to 1.5 m/s by using a speed regulator electrically connected with the drive motor.

4. The method for replacing the seedbed culture substrate according to claim 1, charactered in that in step S5, the speed of the conveyor belt is adjusted to 0.5 m/s by using a speed regulator electrically connected with the drive motor.

5. The method for replacing the seedbed culture substrate according to claim 1, charactered in that in step S4, the flatbed truck loaded with new culture substrate is lifted above the head end of the conveyor belt.

6. A conveyor belt seedbed is characterized by comprising a seedbed frame, a support, a conveyor belt mechanism, an electric cabinet and a driving motor;
The support member is installed on the seedbed frame and is parallel to the front and rear sides of the seedbed frame, and the support member is set lower than the front and rear sides of the seedbed frame;
The conveyor belt mechanism includes the conveyor belt and the rotating shaft;
The rotating shafts are respectively arranged on the left and right sides of the top of the seedbed frame through the bearing seats, and are located at the two ends of the support;
The head and tail ends of the conveyor belt are driven by the rotating shafts on the left and right sides of the top of the seedbed frame;
The rotating shaft is connected with the output shaft of the driving motor;
The electric control box is electrically connected with the driving motor;
The electric control box and the drive motor are both installed on the seedbed frame.

7. The conveyor belt seedbed according to claim 6, characterized in that the support is a guide rail which is located between the upper layer and the lower layer of the conveyor belt;
The number of said guide rails is more than two.

8. The conveyor belt seedbed according to claim 6, charactered in that the electric control box is connected to the drive motor through the governor.

9. The conveyor belt seedbed according to claim 6, charactered in that the conveyor belt is provided with a plurality of ventilation holes.

10. The conveyor belt seedbed according to claim 6, charactered in that the bottom of the support foot of the seedbed frame is provided with universal wheels.
